(19) United States
(12) Patent Application Publication
(10) Pub. No.: US 2012/0245909 A1
(43) Pub. Date: Sep. 27, 2012

(54) DATA-BASED MODELS FOR PREDICTING AND OPTIMIZING SCREW EXTRUDERS AND/OR EXTRUSION PROCESSES

(75) Inventors: Michael Bierdel, Leverkusen (DE); Thomas Mrziglod, Bergisch Gladbach (DE); Linus Görlitz, Koln (DE)

(73) Assignee: BAYER INTELLECTUAL PROPERTY GMBH, Monheim (DE)

(21) Appl. No.: 13/515,486

(22) PCT Filed: Dec. 14, 2010
(86) PCT No.: PCT/EP2010/069608

§ 371 Date: Jun. 18, 2012

(30) Foreign Application Priority Data
Dec. 18, 2009 (EP) 102009059073.0

(51) Int. Cl. G06F 17/50

(52) U.S. Cl. 703/2

(57) ABSTRACT

The present invention relates to the technical field of screw extruders and the optimization of screw extruders and extrusion processes. The subject matter of the present invention is a method for optimizing the geometry of screw extruders and for optimizing extrusion processes. The subject matter of the present invention is also a method for producing screw extruders. The subject matter of the present invention is also a computer system and a computer program product with which the methods according to the invention can be performed.

The present invention relates to the technical field of screw extruders and the optimization of screw extruders and extrusion processes. The subject matter of the present invention is a method for optimizing the geometry of screw extruders and for optimizing extrusion processes. The subject matter of the present invention is also a method for producing screw extruders. The subject matter of the present invention is also a computer system and a computer program product with which the methods according to the invention can be performed.

The ongoing optimization of processes and the improvement of product properties is one of the main driving forces for research and development in industry. In this respect, the supporting use of mathematical methods has long been state of the art.

Optimizations are increasingly being carried out with the aid of simulations on a computer, in order for example to avoid to the greatest extent complex experiments with expensive raw materials and the disposal of waste occurring in the experiments.

This applies in particular to the optimization of screw extruders. Screw extruders are used, for example, in the preparation, compounding and processing of plastics and foods. The closely intermeshing twin-screw shaft with shafts rotating in the same direction is of dominant significance among the extruders for this. A major advantage of the closely intermeshing co-rotating screw by contrast with the single-shaft machines is that, apart from the necessary clearances, the threads wipe, and consequently clean, one another fully. Screw extruders are described in detail in the following publication [1]: K. Kohlgrüber, Der gleichläufige Doppelschneckenextruder [the co-running twin-screw extruder], Hanser Verlag, 2007. In this publication, the structure, function and operation of twin- and multi-shaft extruders are explained at length.

It can easily be appreciated that, for optimizing a screw extruder in an extrusion process, it is not advisable for commercial reasons to produce a large number of different screw extruders in order to test them for their quality experimentally, since the production of screw extruders involves high costs. Therefore, simulations play an important part in the optimization of screw extruders and extrusion processes.

In publication [1], flow simulations and their role in the optimization of extruders and extrusion processes are discussed in more detail on pages 147 to 168.

The aim of the flow simulations is to obtain a deeper understanding of the flow processes occurring in the extruder, in order together with a small number of experiments to ensure a dependable and cost-effective extruder design.

Simulations are therefore intended to serve for recording processes that cannot be measured experimentally, or only with difficulty. In the area of twin-shaft extruders, for example, only integral variables such as the torque of the shafts, the pressure and the temperature at the die can be measured. On the other hand, a flow simulation provides local information on pressure, speed and temperature in the entire computational range. Findings about shear rates and heat transfer coefficients are additionally obtained by the calculation of gradients. In the computational model, the complexity of the models can be increased step by step. This allows findings as to which process variables are decisive for product quality to be obtained. Extrusion processes can be optimized by varying the operating states.

It is disadvantageous in this respect that a separate computational model generally has to be generated for each question. In addition, simulations that have already been carried out can only be reused with difficulty, or not at all, for related questions or other questions.

This also becomes clear from the examples of simulation calculations in screw extruders that are presented in [1] on pages 151 to 165. Each question is tackled in a three-stage process. In the first step (pre-processing), the geometry of the screws is defined and transformed into a form that allows flow simulations (grid generation). In the second step (flow simulation), after defining a flow model and entering material and operating data for solving corresponding differential equations, flow fields are calculated. In the third step (post-processing), a comprehensive analysis of the calculated flow fields is performed with regard to the preceding question. In the case of a new or changed question, all the steps must be taken once again and the time-consuming calculations must be carried out once again. The results are not in a form that can be reused for similar questions. There is no existing system that stores processes once simulated and keeps them in a form in which they can be used at a later time to tackle comparable questions with less computational effort.

Added to this there is also the problem, especially with the optimization of screw extruders, that the parameters that define a process are not freely selectable, and that the structural design of paired fully wiping screw elements is not a trivial problem. This is to be briefly explained in more detail. According to publication [1] (page 151), the geometry of a threaded element of the Erdmenger type is uniquely defined by the following 6 specified items: number of flights, barrel diameter, centreline distance, clearance between screw and barrel, clearance between adjacent screws and pitch. Let us assume that a simulation has been carried out with a set of parameters specified in [1] on page 151. The number of flights was 2 and the initial temperature was 300° C. It is then easily possible to set the temperature at the beginning of a simulation, for example to 310° C. or 320° C. and to carry out a new simulation. However, it is not so easy to increase the number of flights from 2 to 3 or 4. What do pairs of screw elements look like if the number of flights is increased on the basis of a set of geometrical parameters? Is it permissible in the first place to vary the number of flights while retaining the other parameters? Does changing one parameter (for example the number of flights) mean that screw elements with paired fully wiping profiles are still obtained?

The problem with screw elements is that, in the prior art there is no known general design specification for generating any desired screw profiles that are fully wiping in pairs. There are not many screw elements for which a design specification exists. For example, it is known (see [1], pages 96 to 98) that the self-cleaning Erdmenger screw profile can be made up of arcs of a circle. Another method for generating Erdmenger screw profiles is found in the publication [2] by Booy: “Geometry of fully wiped twin-screw equipment”, Polymer Engineering and Science 18 (1978) 12, pages 973-984.

In the publications mentioned, screw profiles are generated by making use of the particular kinematic phenomenon that the rotation of two shafts in the same direction about their stationary axes is kinematically identical to the “translational motion without rotation” of one shaft about another, in this case stationary, shaft. This phenomenon can be used for the stepwise generation of screw profiles. The first screw (the “generated” screw) remains stationary in this consideration and the second screw (the “generating” screw) is moved in a translational manner around the first screw on an arc of a circle. It is then possible to prescribe part of the profile on the second screw and examine which profile is thereby generated on the first screw. The generated screw is to a certain extent “cut out” by the generating screw. In [1], however, it is not specified by what method the part on the second screw, which is prescribed, is itself to be generated. In [2], one possible approach as to how it is possible to generate the profiled portion that can be used as a basis, and from which the remaining profile is generated, is described. However, this approach is mathematically very complex and in particular is not universally applicable, that is to say it is not possible to generate any desired profiles for screw elements.

To sum up, it can be stated that simulation calculations can be used for the optimization of screw extruders and extrusion processes. However, the procedure described in the prior art is not very efficient, since a new time-consuming simulation has to be carried out for each question. In the area of extruder screws, there is the additional problem that there is no general design specification for paired fully wiping screw elements, with the result that a variation of the values for the parameters that define an extruder screw is not readily possible.

The prior art accordingly gives rise to the object of providing a more efficient method for optimizing screw extruders and/or extrusion processes. The method sought is intended in particular to be suitable for also identifying optimized geometries for extruders. To this extent, there is also the object of providing a method for generating optimized screw extruders.

This object is achieved according to the invention by divorcing the simulation calculations from the actual optimization. According to the invention, firstly a large number of simulation calculations are carried out in a previously defined parameter space. The results of the simulation calculations are used to generate a data-based model for this parameter space. The data-based model describes the defined parameter space and provides forecast values for all the combinations of values of interest for the stored parameters.

Consequently, the results of the simulation calculations are available for a large number of different questions and no further simulation calculations have to be carried out to answer an actual question. On the basis of the data-based model, predictions for actual questions can be made in a very much shorter time them would be required for carrying out a simulation calculation. The data-based model can also be used for optimizing parameter values for extruders and/or extrusion processes.

According to the invention, the time-consuming individual simulation for an actual question is consequently replaced by an overall model that only has to be generated a single time. The high computational effort is a one-off event and can be automated to the greatest extent. It is decisive that the results of the simulations are stored in a form—to be precise in the form of the data-based model—in which they are available for later questions. On account of the particular nature of the data-based model, it is not just that the individual simulation calculations are of use for the respective individual simulation but that the data-based model allows the creation of a tool with which results for combinations of values that have not been included in the simulation calculation can also be determined by interpolation.

When there is a question, corresponding values are entered into the data-based model and forecast values for the results can be determined very quickly in comparison with individual simulation. For a question, it is no longer necessary to build up a corresponding simulation model and carry out the corresponding simulation calculations.

A first subject matter of the present invention is consequently a method for creating a forecasting tool for screw extruders and/or extrusion processes, at least comprising the following steps
(a) defining a parameter space,
(b) selecting representative combinations of values within the parameter space,
(c) calculating result characteristics for the selected combinations of values with the aid of simulation calculations,
(d) creating a data-based model on the basis of the selected combinations of values and the calculated result characteristics,
(e) possibly repeating one or more of steps (a) to (e), until the result characteristics can be calculated sufficiently accurately with the aid of the data-based model.

Steps (a) to (e) of the method according to the invention are preferably carried out in the specified sequence.

In step (a) of the method according to the invention, a parameter space is defined. This involves firstly defining the parameters that are required for the simulation of extrusion processes. A distinction can be drawn between three groups of sets of parameters: parameters for describing the geometry of the screw extruders, parameters for describing the extruded material and process parameters.

As already described above, the description of the geometry of screw extruders is not a trivial problem, since there is no general design specification for paired fully wiping screw extruders, and consequently there are no generally known parameters that uniquely describe all possible paired fully wiping screw extruders.

Surprisingly, however, the fundamental principles on which the geometry of paired fully wiping screw profiles is based have been found. These are presented in Annex 1. Annex 1 constitutes part of the present application.

These fundamental principles allow the definition of parameters that uniquely describe paired fully wiping screw extruders and the creation of design specifications for paired fully wiping screw extruders.

By means of these fundamental principles, the cross-sectional profiles (profiles after a section taken perpendicularly to the axis of rotation) of a pair of fully wiping screw extruders can be described by arcs of a circle. Consequently, the profiles are exactly defined by specifying the centre points, radii and angles of the arcs forming them. Depending on the continuation of the profiles into the third dimension in the direction of the axes of rotation for generating mixing, kneading, conveying or transitional elements, the further parameters for describing the geometry of paired fully wiping screw extruders can be defined, such as for example the pitch in the case of a threaded element. It is also required to specify the clearances (clearance between the screw and the barrel, clearance between the screws).

In this way, the geometries of the screws are exactly defined. However, the screws do not necessarily have to be defined by the coordinates and variables of arcs described above as parameters, but instead, for example, derived variables may also be used for the description thereof Preferably, such derived variables that are expected to have an actual physical influence in reality are used as description variables (parameters). For example, the width of the flight land with which the screw wipes the barrel may be specified as a possible parameter. The width of the flight land has an influence on the introduction of energy into the conveyed material and is therefore an important variable for characterizing a screw extruder.

Parameters which characterize the conveyed material are, for example, the density, the thermal capacity, the thermal conductivity, the viscosity and others. These parameters for the extruded material are often dependent on values for the process parameters. For example, the viscosity is dependent on the processing temperature.

Parameters which characterize the process (process parameters) are, for example, pressure, temperature, rotational speed of the screw extruders, torque of the shafts and others.

Once the parameters themselves are defined, the definition of the parameter space is performed. This means that the ranges of values for the respective parameters that are to be taken as a basis for the simulations are defined. The range of values for the parameter of the initial temperature in the extrusion could be defined, for example, as 0° C. to 500° C.

If it is to be expected or it is found that different materials conveyed and/or different types of screw extruders (will) show completely different behaviours in the simulations, it may be advisable to generate different data-based models for different types of materials conveyed and/or different types of screw extruders. If need be, these different models may be combined later in a single model.

For example, it is advisable with materials conveyed to distinguish between those that show Newtonian flow behaviour and those that are non-Newtonian and to carry out separate simulations and to generate separate models for these.

Furthermore, it is advisable also to consider types of screw extruders separately. One type of screw extruders could be formed, for example, by double-flighted threaded elements with an Erdmenger profile (see [1], pages 151 to 168), while another type could be formed, for example, by single-flighted threaded elements with a reduced flight land angle, as are described in PCT/EP2009/004251.

In step (b) of the method according to the invention, a selection of representative combinations of values within the parameter space is performed. Representative combinations of values are understood as meaning combinations of values that describe the parameter space as comprehensively as possible and cover areas of the parameter space that are as different as possible. The aim is to find combinations of values that describe the parameter space so well that the data-based model into which these combinations of values are entered (together with the results of the simulation calculations) can also make predictions for other values.

For this purpose, the methods known to a person skilled in the art from experimental design are expediently used, such as for example experimental design methods based on the statistical design of experiments such as Placket-Burmann experimental designs, central-composite designs, Box-Behnken experimental designs, D-optimal designs, balanced block designs, methods devised by Shainin or Taguchi and others. Experimental design methods are described, inter alia, in: Hans Bendemer, Optimale Versuchsplanung [optimal design of experiments], Deutsche Taschenbücher series, DTB, volume 23 (ISBN 3-87144-278-X) or Wilhelm Kleppmann, Taschenbuch Versuchsplanung, Produkte and Prozesse optimieren [pocketbook of experimental design, optimizing products and processes], second edition (ISBN 3-446-21615-4). In particular, reference may also be made here to the method described in WO2003/075169A.

It is possible that it will be found at a later time of the method according to the invention that the selected combinations of values do not adequately represent the parameter space (see step (d)). In this case, it may be required to select other and/or further combinations of values (see step (e)).

In step (c) of the method according to the invention, simulation calculations for the selected combinations of values are performed. Various selected scenarios are calculated and it is simulated how different screw extruders behave under different process parameters and/or possibly with the use of different materials (extruded material).

For such simulations, the three-dimensional screw contour must be in a form that makes mathematical calculations by means of a computer possible. The virtual representation of a screw in a computer is advantageously performed as described in [1] on pages 149 to 150 in the form of a so-called computational grid.

The structural design of paired fully wiped screws in a computer is preferably performed firstly by defining their cross-sectional profiles (hereafter also referred to as profiles for short), i.e. by defining the generating screw profile and the generated screw profile. The profiles are for their part defined, preferably by specifying the centre points, radii and angles of the arcs. The fundamental principles presented in Annex 1 and the design specification presented in Annex 1 or a design specification derived therefrom (see PCT/EP2009/003549) are used for this.

On the basis of the two-dimensional profiles, the continuation of the profile into the third dimension, in the direction of the axis of rotation, is then performed. A model of a conveying element, for example, is generated by the profile being turned helically in the axial direction. A model of a kneading element, for example, is generated by the profile being continued in portions in the axial direction, the portions being offset with respect to one another, and therefore discs that are offset with respect to one another are produced.

The representation of the screw extruders in the computer takes place in the form of computational grids. The volume between the inner surface of the barrel and the surfaces of a screw extruder is thereby meshed with a computational grid that consists of polyhedrons, such as for example tetrahedrons or hexahedrons (see for example [1]).

The computational grid and the material data of the extruded material and the operating data of the screw machine in which the screw extruders and the extruded material are used are entered in a program for flow simulation and the flow conditions are simulated (see for example [1]).

The results of the flow simulations are available, for example, in the form of flow, pressure and/or temperature fields (see [1] pages 147 to 168). As described on the pages mentioned in [1], conveying and power characteristics can be determined from the flow simulations. According to the invention, result characteristics are determined from the simulation results and can be set in relation to the combinations of values respectively used. The conveying and power characteristics (see [1] page 158) are preferably used to calculate axial portions and/or slopes of the straight lines (pressure difference as a function of the volumetric flow, power as a function of the volumetric flow) and these are used as result characteristics.

Once the simulation calculations have been carried out and result characteristics determined, the creation of a data-based model is performed (step d)). Such a model is intended to set combinations of values of input variables (input parameters) in relation with the corresponding result characteristics (output parameters). The model is referred to as a data-based model because the model performs these relationships on the basis of the data available (combinations of values, result characteristics), without actual physical relationships between the data having to be known and/or entered.

The generation of data-based models from available input and output variables is general state of the art. Known data-based models are, for example: linear and nonlinear regression models (see for example Hastie, Tibshirani, Friedman: The Elements of Statistical Learning, Springer, 2001), linear approximation methods, artificial neural networks (for example perceptron, recurrent networks) (see for example Andreas Zell, Simulation neuronaler Netze [simulation of neural networks], ISBN 3-486-24350-0 or Raul Rojas: Theorie der Neuronalen Netze [theory of neural networks], ISBN 3-540-56353-9 or McKay, David J. C. (September 2003), Information Theory, Inference and Learning Algorithms, Cambridge: Cambridge University Press, ISBN 0-521-64298-1), support vector machines (see for example B. Schölkopf, A. Smola: Learning with Kernels, MIT Press, 2002), hybrid models (see for example A. A. Schuppert: Extrapolability of structured hybrid models: a key to optimization of complex processes, in: B. Fiedler, K. Gröger. J. Sprekels (Eds.), Proceedings of EquaDiff '99, 2000, pp. 1135-1151 or G. Mogk, T. Mrziglod, A. Schuppert: Application of hybrid models in chemical industry, in: J. Grievink, J. van Schijndel (Eds.), Proceedings of European Symposium on Computer Aided Process Engineering, vol. 12, The Hague, The Netherlands, May 26-29, 2002, Elsevier Science B.V., pp. 931-936 or EP-A1253491).

A hybrid model is preferably used.

All types of model contain parameters that are determined with the aid of the generated simulation data (training) such that the input-output behaviour of the model is optimal in a defined sense. Training methods specific to the various types of model can be found in the literature cited. An efficient training method for two-stage perceptrons, for example, is described in F. Bärmann, F. Biegler-König, Neural Networks 1992, 5(1), 139-144.

Furthermore, in step (d), the assessment of the quality of the model takes place. This may be performed, for example, with the aid of validation data by checking the reliability of the forecast (see for example Chiles, J. -P. and P. Delfiner (1999) Geostatistics, Modeling Spatial Uncertainty, Wiley Series in Probability and statistics). A plausibility check of the dependencies in various regions of the parameter space is preferably performed using prior knowledge.

Consequently, combinations of values for which simulation calculations have been carried out but which have not been used for generating the data-based model (validation data) are preferably used for the assessment of the quality of the model. It is investigated to what extent the data-based model can also predict the results of “unknown” scenarios. In this case, the respective intended use determines the required quality of the model. A measure of the quality of the model is, for example, the maximum deviation between the calculated simulation result and the model result predicted by means of the model. In the modelling of extrusion processes, a maximum deviation of 5%, preferably of 2%, has been found to be an adequate quality of the model.

If the quality of the model is not adequate, according to the invention the parameter space is newly defined and/or other and/or further combinations of values that describe the parameter space are selected. According to the invention, consequently, repetition of one or more of steps (a) to (e) possibly takes place in step (e), until the result characteristics can be calculated sufficiently accurately with the aid of the data-based model.

The result of the described method according to the invention is an optimized data-based model that can be used as a forecasting tool.

The forecasting tool may be available as a program code on a machine-readable data carrier, such as for example a floppy disk, a CD, a DVD, a hard disk, a memory stick or the like. The forecasting tool located on the machine-readable data carrier can be read into a main memory of a computer. By means of the computer and the input and output devices connected to the computer, a user can operate the forecasting tool, i.e. enter values into the data-based model and calculate result characteristics. The user is preferably supported in this by a graphical user interface. It is similarly possible to realize the forecasting tool as a microchip that is operated with suitable peripherals (input and output devices) in a way analogous to the program that can be read in to the computer.

The subject matter of the present invention is also a forecasting tool for screw extruders and/or extrusion processes that has been generated according to the described method for generating the forecasting tool.

The forecasting tool may be used, for example, to calculate the behaviour of new or modified screw extruders in extrusion processes. The forecasting tool may be used, for example, to determine the effect of changed values of the process parameters on the extruded material.

A further subject matter of the present invention is consequently a method for predicting the behaviour of screw extruders in the extrusion of an extruded material. This method comprises at least the following steps:
(I) creating a data-based model as a forecasting tool,
(II) inputting characterizing values for screw extruders, extrusion processes and extruded material into the data-based model,
(III) calculating result characteristics by means of the data-based model,
(IV) outputting a result.

Steps (I) to (IV) of the method according to the invention are preferably carried out in the specified sequence.

The creation of the data-based model in step (I) is performed as described above with respect to the method for creating a forecasting tool for screw extruders and/or extrusion processes.

In step (II), the input of the values that describe the scenario for which a prediction is to be achieved takes place. These are the values for the geometry of the screw extruders, the values that characterize the extruded material and the values that define the extrusion process.

The input is usually performed with a mouse and/or a keyboard on a computer system on which the forecasting tool can be run as a software program.

In step (III), the calculation of result characteristics by means of the data-based model takes place. This calculation is generally performed in a fraction of the time that is necessary for a single simulation.

In step (IV), finally, the output of results takes place. Results may be the calculated result characteristics themselves. These may be displayed as values on a computer screen. Values or variables that are derived from the result characteristics may also be displayed. The presentation of results preferably takes place by graphics and/or by colour codings.

Apart from purely predicting the behaviour of screw extruders in extrusion processes, an optimization of screw extruders and/or extrusion processes is also possible by means of the forecasting tool. A further subject matter of the present invention is consequently a method for optimizing the geometry of screw extruders and/or extrusion processes.

This method comprises at least the following steps:
(A) creating a data-based model as a forecasting tool,
(B) defining a target profile for the screw extruders and/or the extrusion process,
(C) identifying those combinations of values that satisfy the defined target profile and/or come closest to the target profile,
(D) outputting the combinations of values determined in step (C).

Steps (A) to (D) of the method according to the invention are preferably carried out in the specified sequence.

The creation of the data-based model in step (A) takes place as described above with respect to the method for creating a forecasting tool for the screw extruders and/or extrusion processes.

In step (B), the target profile for the screw extruders and/or the extrusion process is defined. The definition of the target profile comprises the drawing up of rules for all the result characteristics (output) that are intended to be met by the sought combinations of values (input). For example, it is possible to define a maximum temperature increase of the extruded material or a minimum pressure build-up that is required to convey the extruded material through the extruder.

The search for those combinations of values that satisfy the prescribed target profile or come closest to it is performed in step (C) using the data-based model. With the aid of the data-based model, the result characteristics (output parameters) for a large number of combinations of values (input parameters) can be calculated in a very short time, with the result that a specific variation of the values for the input parameters and comparison of the values for the output parameters with the target profile leads to the sought input parameters that satisfy the target profile or come closest to it. This search for the “optimum” combinations of values for achieving a prescribed profile may be supported by known optimizing methods, such as for example Monte Carlo methods, evolutionary optimization (genetic algorithms), simulated annealing or others. An overview of optimizing methods is given, for example, by the book by M. Berthold et al., Intelligent Data Analysis, Springer, Heidelberg 1999.

In step (D), finally, the output of the combinations of values that satisfy the defined target profile and/or come closest to it takes place. Preferably, the output of the calculated result parameters and the deviation of the calculated result parameters from the target profile also takes place. The output may take place in the form of figures and/or graphics on a computer screen or a printer.

The forecasting tool may also be used for the generation of new screw extruders. A further subject matter of the present invention is therefore a method for producing screw extruders, at least comprising the following steps:
(i) creating a data-based model as a forecasting tool,
(ii) defining a target profile for the screw extruders and/or the extrusion process,
(iii) identifying those combinations of values for the screw extruders that satisfy the defined target profile and/or come closest to the target profile,
(iv) outputting and/or storing the combinations of values determined in step (iii),
(v) creating screw extruders on the basis of the combinations of values determined in step (iii).

Steps (i) to (v) of the method according to the invention are preferably carried out in the specified sequence.

Steps (i) to (iii) correspond to steps (A) to (C) of the method for optimizing the geometry of screw extruders and/or extrusion processes. Accordingly, the geometry of the screw extruders that is optimized for a prescribed application case is determined. This geometry calculated on the computer is then used for generating an actual screw extruder (step (v)). The geometry data of the screw extruders are preferably transformed into a format that can be fed directly to a CNC machine tool (CNC=Computerized Numerical Control) for generating the screw elements. Such formats are known to a person skilled in the art.

Once the geometries have been generated in the way described, the screw extruders can be generated, for example by a milling machine, a turning machine or a whirling machine. Preferred materials for generating the screw extruders are steels, in particular nitriding steels, chromium steels, tool steels and special steels, powder-metallurgically produced metallic composite materials based on iron, nickel or cobalt, engineering ceramic materials, such as for example zirconia or silicon carbide.

All the methods according to the invention presented here are preferably performed on a computer. The subject matter of the present invention is also a computer system for performing one of the methods according to the invention. Furthermore, a further subject matter of the present invention is a computer program product with program coding means for performing one of the methods according to the invention on a computer.

The invention is explained in more detail below on the basis of examples, without however being restricted thereto.

### EXAMPLE 1

### Creation of a Forecasting Tool for a Double-Flighted Screw Element with an Erdmenger Screw Profile

The present example describes a method for creating a forecasting tool for screw extruders and/or extrusion processes, comprising the following steps

(a) defining a parameter space,

(b) selecting representative combinations of values within the parameter space,

(c) calculating result characteristics for the selected combinations of values with the aid of simulation calculations,

(d) creating a data-based model on the basis of the selected combinations of values and the calculated result characteristics,

(e) possibly repeating one or more of steps (a) to (e), until the result characteristics can be calculated sufficiently accurately with the aid of the data-based model.

Step (a): Defining the parameter space.

As described in [1] on page 151, the geometry of a conveying element with an Erdmenger screw profile is uniquely defined by specifying 6 geometrical parameters. These 6 parameters are the number of flights, the barrel diameter, the centreline distance, the clearance between the screw and the barrel, the clearance between the two screws and the pitch. In order to reduce the number of parameters and obtain a representation with general validity, dimensionless geometrical parameters are expediently introduced. The barrel diameter is chosen as the reference variable. It follows from this that the geometry of a conveying element with an Erdmenger screw profile is uniquely defined by specifying 5 dimensionless geometrical parameters. These 5 parameters are the number of flights Z, the dimensionless centreline distance A, the dimensionless clearance between the screw and the barrel D, the dimensionless clearance between the two screws S and the dimensionless pitch T.

In practice, conveying elements with a number of flights Z of 1, 2 or 3 are typically used. A separate forecasting tool is expediently created for each number of flights. In this example, a double-flighted conveying element is considered. Therefore, Z=2. Consequently, there remain four dimensionless characteristics for which a range of values has to be defined. For the dimensionless centreline distance A, a range of values of 0.72≦A≦0.93 was chosen. For the dimensionless clearance between the screw and the barrel D, a range of values of 0.002≦D≦0.024 was chosen. For the dimensionless clearance between the two screws S, a range of values of 0.004≦S≦0.060 was chosen. For the dimensionless pitch T, a range of values of 0.3≦T≦4.0 was chosen.

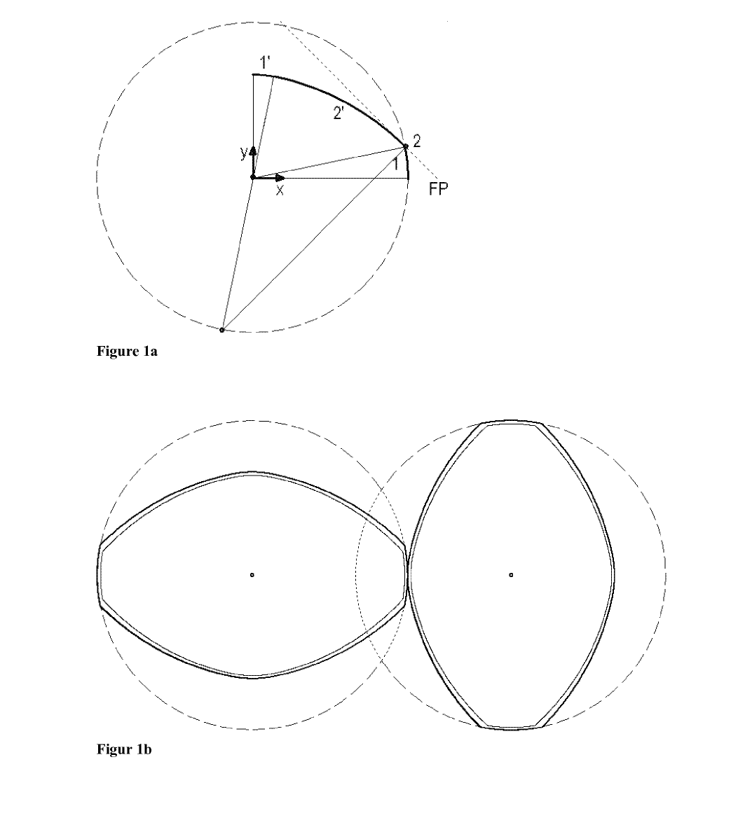

In FIG. 1a, the structural design of a self-cleaning and closely intermeshing Erdmenger screw profile is shown. An Erdmenger screw profile has two axes of symmetry, which intersect at an angle of 90°. It is therefore adequate to generate one quarter of the screw profile and then obtain the complete screw profile by reflection at the axes of symmetry.

FIG. 1a is described in more detail below. In the middle of the figure lies the xy system of coordinates, at the origin of which the point of rotation of the screw profile is located. The arcs of the screw profile are identified by thick, solid lines, which are provided with the respective numbers of the arcs. The centre points of the arcs are represented by small circles. The centre points of the arcs are joined by thin, solid lines both to the starting point and to the end point of the associated arc. The straight line FP is represented by a thin, dotted line.

One quarter of an Erdmenger screw profile is obtained from 2×2 arcs, which correspond to one another. The sum of the radii of two corresponding arcs (1 and 1′, 2 and 2′) is equal to the centreline distance. The radii 1 and 1′ are equal to the outer radius or equal to the core radius. The radii 2 and 2′ are equal to zero or equal to the centreline distance. The centre angles of two corresponding arcs are of the same size. The sum of the centre angles 1 and 2 is equal to π/4. The centre points of the arcs 1 and 1′ lie at the origin of the coordinates. All the arcs merge tangentially with one another. The arcs 2 and 2′ make contact with the straight line FP at a common point. The distance of the straight line FP from the origin of the coordinates is equal to half the centreline distance and the slope of this line is −1.

In FIG. 1a, the dimensionless centreline distance is A=0.8333, the dimensionless outer radius is RA=0.5 and the dimensionless core radius is RK=0.3333. The corresponding arcs 1 and 1′; and 2 and 2′ have a centre angle in radian measure of 0.1997 and 0.5857, respectively.

As shown, for example, in the publication [1] on pages 27 to 30, arrangements comprising screw elements and barrels always have in practice what are known as clearances. A person skilled in the art knows methods for deriving a screw profile with clearances from a prescribed, self-cleaning, closely intermeshing screw profile. Known methods for this are, for example, the possibility described in [1] on pages 28 et seq. of increasing the centreline distance, the longitudinal-sectional equidistants and the spatial equidistants. In the case of increasing the centreline distance, a screw profile of a smaller diameter is constructed and pulled apart by the amount of clearance between the screws. In the case of the method of longitudinal-sectional equidistants, the longitudinal-sectional profile curve (parallel to the axis of rotation of the respective element) is displaced inwards perpendicularly to the profile curve, in the direction of the axis of rotation, by half the screw-screw clearance. In the case of the method of spatial equidistants, starting from the space curve on which the screw elements clean one another, the screw element is reduced in size by half the screw-screw clearance in the direction perpendicular to the surfaces of the fully wiping profile. In this example, the spatial equidistant is used.

FIG. 1b shows both the self-cleaning, closely intermeshing Erdmenger screw profile according to FIG. 1a and the screw profile derived therefrom with clearances within an octagonal screw barrel. The screw barrel is represented by a thin, dashed line. Within the penetration of the two barrel bores, the two bores are identified by thin, dotted lines. The centre points of the two barrel bores are identical to the two points of rotation of the screw profiles and are respectively identified by a small circle. The closely intermeshing, self-cleaning screw profiles are identified by a thick, solid line. The screw profiles with clearances are represented by a thin, solid line. The screw profile with clearances was obtained by means of the method of spatial equidistants. The dimensionless clearance between the two screws is S=0.02. The dimensionless clearance between the screw and the barrel is D=0.01. The dimensionless pitch of the associated screw element is T=1 (in the case of the method of spatial equidistants, the screw profile with clearance depends on the pitch).

Step (b): Selection of representative combinations of values within the parameter space.

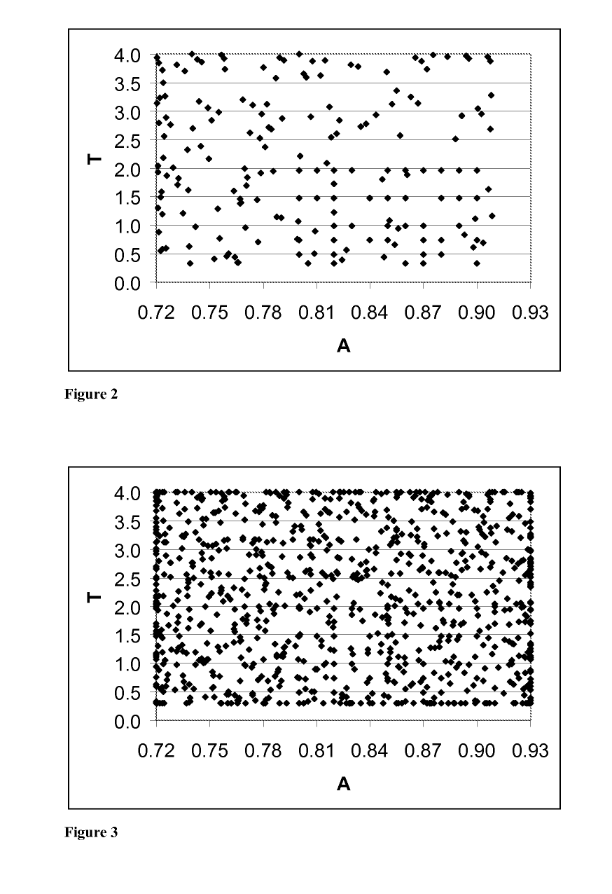

FIG. 2 shows 255 combinations of values between the dimensionless centreline distance A and the dimensionless pitch T in the chosen parameter space. The combinations of values may be defined in various ways. If a specific value within the parameter space is of particular interest, a particularly large number of combinations of values can be placed on this value. For example, the dimensionless centreline distance A=0.82 is of particular interest because customary screw extruders have precisely this centreline distance. Therefore, at A=0.82 there are a particularly large number of combinations of values on an imaginary line between T=0.3 and T=2.0. Analogous considerations find between A=0.8 and A=0.9 particularly large numbers of combinations of values at T=2.0. Further combinations of values may, for example, be distributed such that the individual combinations of values are as far away from one another as possible. In the range between A=0.91 and A=0.93, there are initially no combinations of values. The two-dimensional distance of the combinations of values in FIG. 2 cannot indicate the true distance in the four-dimensional parameter space.

FIG. 3 shows 1015 combinations of values between the dimensionless centreline distance A and the dimensionless pitch T in the chosen parameter space. If need be, parameter spaces can be subsequently increased in size. There are now likewise combinations of values in the range from A=0.91 to A=0.93. Furthermore, apart from a general increase in the number of combinations of values, combinations of values are particularly set at the periphery of the parameter space. Data-based models only allow very limited extrapolation. It is therefore important to provide the peripheries of the parameter space especially with combinations of values, in order to ensure interpolation up to the periphery of the parameter space.

Step (c): Calculation of result characteristics for the selected combinations of values with the aid of simulation calculations.

On the basis of the selected combinations of values, the calculation of result characteristics is performed with the aid of simulation calculations.

Result characteristics may be, for example, geometrical characteristics. Geometrical characteristics are, for example, the flight land angle of a screw element, the pitch angle of a screw element with respect to the outer radius, the pitch angle of a screw element with respect to the core radius, the cross-sectional area of a screw element, the screw surface of a screw element, the barrel surface, the sum of the screw surface and the barrel surface, the free cross-sectional area of a screw element (that is to say the cross-sectional area between the screw element and the barrel through which flow can pass) and the already mentioned areas with respect to the pitch of a screw element (that is to say, for example, the screw surface with respect to the pitch). The geometrical characteristics mentioned are advantageously calculated in a simulation program for generating geometries of screw elements, in particular for generating geometries of conveying elements, kneading elements, mixing elements and transitional elements.

Result characteristics may be, for example, characteristics for assessing the grid quality of a computational grid that is used for calculating the flow processes in a screw element. Characteristics for assessing the grid quality of a computational grid are, for example, skewness, aspect ratio and warpage (see Gambit's User's Guide, Fluent Inc, Lebanon, N.H., USA, 2006). The mentioned characteristics of grid quality are advantageously calculated in a simulation program for generating computational grids for screw elements, in particular for generating computational grids for conveying elements, kneading elements, mixing elements and transitional elements.

Result characteristics may be, for example, characteristics for characterizing the operating behaviour of a screw element. As a person skilled in the art knows, and as can be read in [1] on pages 129 to 146, the operating behaviour of screw elements such as conveying, kneading and mixing elements can be described by a pressure-difference/throughput characteristic and by a power/throughput characteristic. To make transferability to different extruder sizes easier, the variables of pressure difference, power and throughput are often used in their dimensionless form. In the case of a plastic composition with Newtonian flow behaviour, there is a linear relationship both between pressure difference and throughput and between power and throughput. In the pressure-difference/throughput characteristic, the intersection points of the axes are labelled A1 and A2 ([1], page 133). The operating point A1 denotes the inherent throughput of a screw element. The operating point A2 denotes the pressure build-up capacity without throughput. In the power/throughput characteristic, the intersection points of the axes are labelled B1 and B2 ([1], page 136). The point B1 is what is known as the turbine point. If the throughput is greater than B1, power is output to the screw shafts. The operating point B2 denotes the power requirement without throughput.

In a pressure build-up zone, only some of the power introduced may be converted into flow power. The remainder of the introduced power dissipates. The flow power is calculated as the product of throughput and pressure difference. As a person skilled in the art will readily recognize, the flow power at the intersection points A1 and A2 of the axes is in each case equal to 0, since either the pressure difference is equal to 0 (A1) or the throughput is equal to 0 (A2). In the region between A1 and A2, both the pressure difference and the throughput are greater than 0, resulting in a positive flow power. If the flow power of an operating point provided by a throughput is divided by the power that is output by the screw shafts at this operating point, the pressure build-up efficiency at this operating point is obtained. By deriving efficiency on the basis of throughput and subsequent root finding, the maximum efficiency of a screw element can be found.

As described in K. Kohlgrüber, Co-Rotating Twin-Screw Extruders, Hanser Verlag, 2007, ISBN 978-3-446-41372-6, on page 126, a partial filling occurs in the screw element if the throughput per revolution is less than the operating point A1 and there is no counter pressure. If the degree of filling tends towards zero, the power requirement of a screw element is denoted by the operating point B4. In this operating state, the shafts and barrel are wetted with melt, but no product is conveyed. Up until complete filling of the screw element, which is achieved at the operating point A1, the power requirement increases with the degree of filling. The power requirement required at the operating point A1 is denoted by B5.

Characteristics for characterizing the operating behaviour of a screw element are, for example, the operating points A1, A2, B1, B2, B4 and B5 and also the pressure build-up efficiency for a given product throughput and the maximum achievable pressure build-up efficiency. The mentioned characteristics for characterizing the operating behaviour of a screw element, in particular a conveying element, a kneading element, a mixing element and a transitional element, are advantageously calculated in a flow simulation program (CFD program).

Step (d): Creation of a data-based model on the basis of the selected combinations of values and the calculated result characteristics.

The generation of data-based models from available input and output variables is general state of the art. Known data-based models are, for example: linear and nonlinear regression models, linear approximation methods, artificial neural networks, support vector machines, hybrid models.

For creating a forecasting tool for a double-flighted screw element with an Erdmenger screw profile, a hybrid model was used.

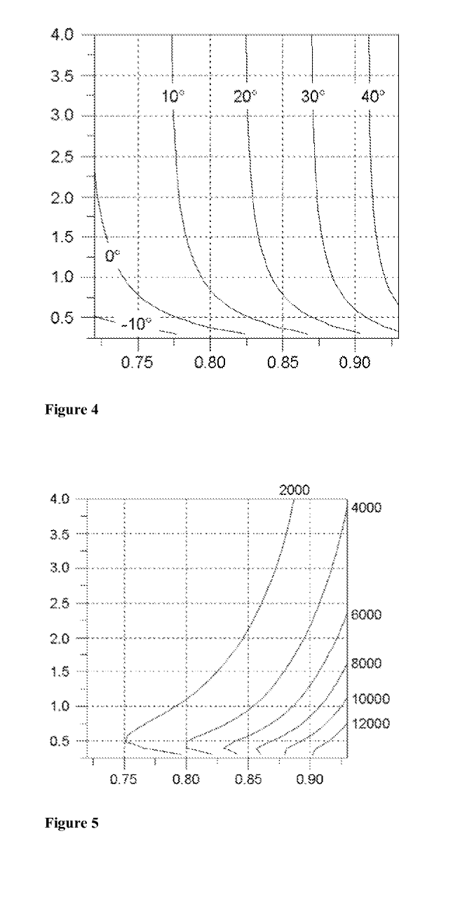

On the basis of the combinations of values according to FIG. 3, FIG. 4 shows the predicted flight land angle of a double-flighted conveying element in dependence on the dimensionless centreline distance A (horizontal axis) and the dimensionless pitch T (vertical axis). The dimensionless clearance between the screws is set to S=0.02. The dimensionless clearance between the screw and the barrel is set to D=0.01.

On the basis of the combinations of values according to FIG. 3, FIG. 5 shows the predicted pressure build-up parameter A2 of a double-flighted conveying element in dependence on the dimensionless centreline distance A and the dimensionless pitch T. The dimensionless clearance between the screws is set to S=0.02. The dimensionless clearance between the screw and the barrel is set to D=0.01.

A comparison carried out between the calculated and the predicted pressure build-up parameter A2 produced the following results. If all the combinations of values are included in the comparison, there is an average deviation between the calculation and the prediction of 6.75% with a standard deviation of 11.3%. If the range of the combinations of values is restricted to screw elements with a positive flight land angle, there is an average deviation between the calculation and the prediction of 4.04% with a standard deviation of 5.16%. If the range of the combinations of values is restricted further, to the extent that a distance from the limits of the parameter space of in each case 5% must be maintained (length of a parameter equals 100%), there is an average deviation between the calculation and the prediction of 3.22% with a standard deviation of 3.59%.

It is clear from a comparison of FIGS. 4 and 5 that, especially in the range of flight land angles of less than or equal to zero, the pressure build-up parameter A2 changes very greatly. As a result, with the same density of the combinations of values, an inferior prediction accuracy is achieved in this range. Furthermore, the prediction accuracy decreases somewhat towards the periphery, in spite of setting additional combinations of values at the peripheries of the parameter space.

Step (e): Possibly repeating one or more of steps (a) to (e), until the result characteristics can be calculated sufficiently accurately with the aid of the data-based model.

In the course of this example, steps (b) to (d) were repeated. A prediction accuracy of on average 3.22% with a standard deviation of 3.59% is often not acceptable for a design of screw extruders. The number of combinations of values was increased to a total of 3358. The further combinations of values were on the one hand distributed as evenly as possible in the parameter space, on the other hand once again additional combinations of values were set at the peripheries of the parameter space. The possibility of setting further combinations of values in a way corresponding to a local deviation variable or local gradients of the result characteristics was not taken up. After the calculation of the result characteristics and the generation of a new data-based model, once again a comparison was carried out between the calculated and the predicted pressure build-up parameter A2. If all the combinations of values are included in the comparison, there is an average deviation between the calculation and the prediction of 3.07% with a standard deviation of 4.74%. If the range of the combinations of values is restricted to screw elements with a positive flight land angle, there is an average deviation between the calculation and the prediction of 1.91% with a standard deviation of 2.41%. If the range of the combinations of values is restricted further, to the extent that a distance from the limits of the parameter space of in each case 5% must be maintained (length of a parameter equals 100%), there is an average deviation between the calculation and the prediction of 1.52% with a standard deviation of 1.55%. There is a reduction in the average deviation and the standard deviation of up to 58%.

A prediction accuracy of on average 1.52% with a standard deviation of 1.55% is adequate for a design of screw extruders.

### EXAMPLE 2

### Creation of a Forecasting Tool for a Double-Flighted Screw Element with a Reduced Flight Land Angle in Comparison with an Erdmenger Screw Profile

Step (a): Defining the parameter space.

Screw elements with a reduced flight land angle, referred to hereafter as Rita screw elements (Rita=reduced tip angle), have a reduced flight land angle in comparison with the Erdmenger screw profile. The relevant flight land angle R is in this case defined by the quotient of the flight land angle of the Rita screw profile and the flight land angle of the Erdmenger screw profile, the self-cleaning, closely intermeshing screw profiles being considered in each case. For the relevant flight land angle R, a parameter space of 0≦R≦1 is chosen. The further dimensionless parameters and associated parameter spaces of the Rita screw element correspond to the Erdmenger element from Example 1.

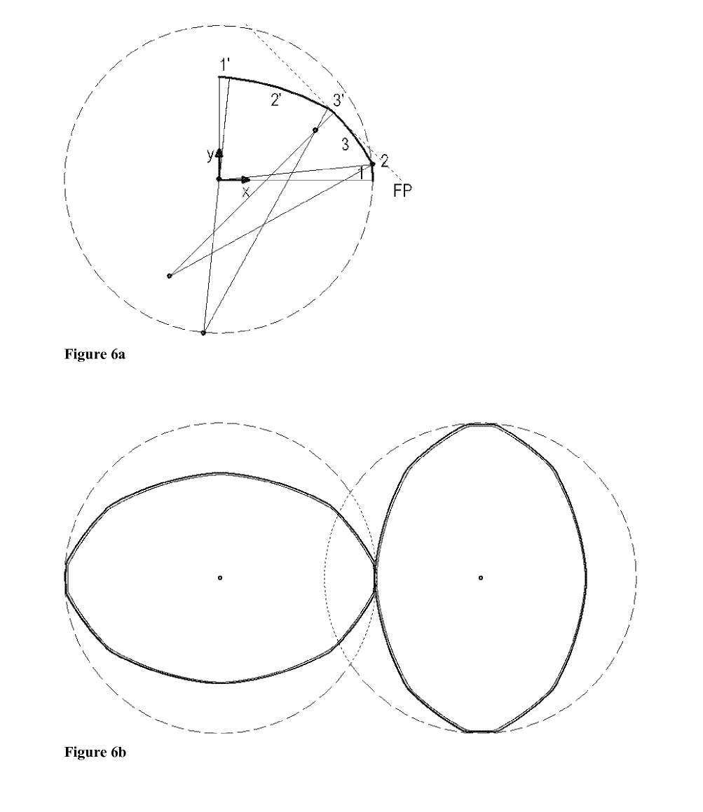

FIG. 6a shows a self-cleaning, closely intermeshing Rita screw profile. The basic structure of FIG. 6a corresponds to that of FIG. 1a. One quarter of a Rita screw profile is obtained from 2×3 arcs, which correspond to one another. In FIG. 6a, the dimensionless centreline distance is A=0.8333. The radii 1 and 1′ are equal to the outer radius RA=0.5 or equal to the core radius RK=0.3333. The radii 2 and 2′ are equal to 0 or equal to the centreline distance. The radii 3 and 3′ are equal to 0.9 of the centreline distance or equal to 0.1 of the centreline distance. The corresponding arcs 1 and 1; 2 and 2′; and 3 and 3′ have a centre angle in radian measure of 0.0999, 0.4035 and 0.2820, respectively. The centre points of the arcs 1 and 1′ lie at the origin of the coordinates. All the arcs merge tangentially with one another. The arcs 3 and 3′ make contact with the straight line FP at a common point.

FIG. 6b shows both the self-cleaning, closely intermeshing Rita screw profile according to FIG. 6a and a screw profile derived therefrom with clearances within an octagonal screw barrel. The structure of FIG. 6b corresponds to FIG. 1b. The screw profile with clearances is obtained by means of the method of spatial equidistants. The dimensionless clearance between the two screws is S=0.01. The dimensionless clearance between the screw and the barrel is D=0.01. The dimensionless pitch of the associated screw element is T=1.

Step (b): Selection of representative combinations of values within the parameter space.

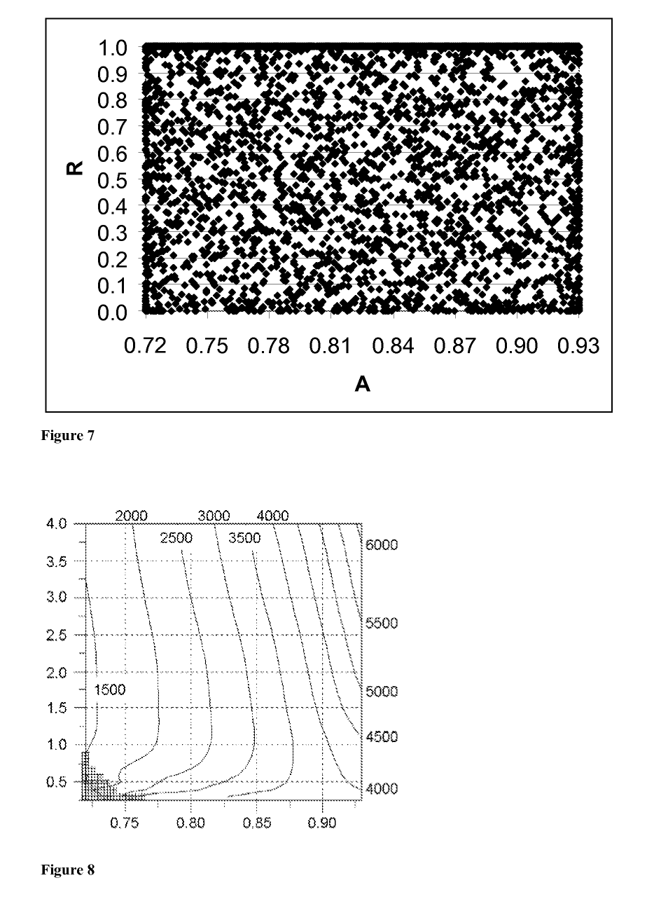

FIG. 7 shows 6005 combinations of values between the dimensionless centreline distance A and the relative flight land angle R in a chosen parameter space. Of these combinations of values, 3358 combinations of values are taken over from Example 1 with a relative flight land angle of R=1. A further 2647 combinations of values denote relative flight land angles of less than R=1. The selection of combinations of values takes place by the method described in the first example.

On the basis of the Erdmenger screw element, new screw elements can be seamlessly integrated into a forecasting tool for screw extruders and/or extrusion processes. The forecasting tool comprises both the new Rita screw element and the Erdmenger screw element. Alternatively, it is possible to create a forecasting tool that is made up only of the 2647 combinations of values with a relative flight land angle of less than R=1.

Step (c): Calculation of result characteristics for the selected combinations of values with the aid of simulation calculations.

On the basis of the selected combinations of values, the calculation of result characteristics is performed with the aid of simulation calculations. The same result characteristics as in the first example are calculated.

Step (d): Creation of a data-based model on the basis of the selected combinations of values and the calculated result characteristics.

A hybrid model is used for creating a forecasting tool for a double-flighted screw element with a Rita screw profile. The generated data-based model allows the prediction of the desired result characteristics.

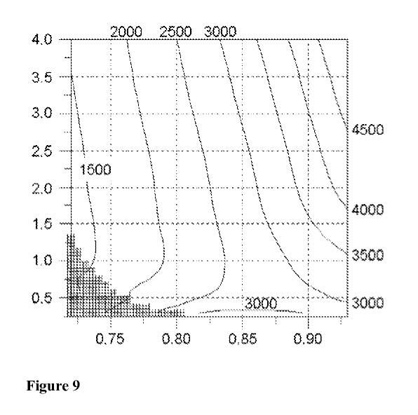

On the basis of the combinations of values according to FIG. 7, FIG. 8 shows the predicted operating point B2 of a double-flighted Rita conveying element with a relative flight land angle of R=1—corresponding to an Erdmenger screw element—in dependence on the dimensionless centreline distance A (horizontal axis) and the dimensionless pitch T (vertical axis). The dimensionless clearance between the screws is set to S=0.01. The dimensionless clearance between the screw and the barrel is set to D=0.01. FIG. 9 likewise shows the predicted operating point B2 of a double-flighted Rita conveying element with a relative flight land angle of R=0.5. It is comparatively found that a smaller relative flight land angle R leads to a smaller amount of energy being introduced into the extruder.

The shaded region marked respectively at the bottom left in FIGS. 8 and 9 reflects the region in which there are negative flight land angles. The forecasting tool allows the determination of a screw element with requirements for, for example, B2 in combination with further requirements for, for example, the flight land angle.

A comparison carried out between the calculated and the predicted operating point B2 produced the following results. If all the combinations of values that have a positive flight land angle and maintain a distance from the limits of the parameter space of in each case 5% (length of a parameter equals 100%) are included in the comparison, there is an average deviation between the calculation and the prediction of 0.93% with a standard deviation of 0.97%.

Step (e): Possibly repeating one or more of steps (a) to (e), until the result characteristics can be calculated sufficiently accurately with the aid of the data-based model.

On account of the high prediction accuracy, no repetition with further combinations of features was necessary.

### Annex

### Design Specification for Generating Paired Fully Wiping Screw Extruders Rotating in the Same Direction

Surprisingly, the fundamental principles on which the geometry of paired fully wiping screw profiles are based have been found. These are described in the applications PCT/EP2009/003549 and PCT/EP2009/004249. These fundamental principles allow design specifications for paired fully wiping screw extruders to be created, and consequently also for parameters that clearly describe paired fully wiping screw extruders to be defined.

The fundamental principles are:
1. The profiles of a generating screw profile and a generated screw profile can always be made up of arcs of a circle.
The size of an arc is given by specifying its centre angle and its radius. Hereafter, the centre angle of an arc is referred to for short as the angle of an arc. The position of an arc can be defined by the position of its centre point and by the position of its starting point or end point, it not being fixed which is the starting point and which is the end point, since an arc can be constructed starting from the starting point and ending at the end point clockwise or anticlockwise. The starting point and the end point are therefore interchangeable.
2. The arcs of the profiles merge tangentially with one another at their starting points and end points.
3. Fundamental principle 2 also applies to profiles with a “kink”, if the kink is described by an arc of which the radius is equal to 0.
The “size of the kink” is given by the corresponding angle of the arc with the radius 0, i.e. in the case of a kink there is a transition from a first arc through rotation about the angle of a second arc with a radius of zero into a third arc. Or to put it another way: a tangent to the first arc at the centre point of the second arc with the radius of zero intersects a tangent to the third arc likewise at the centre point of the second arc at an angle that corresponds to the angle of the second arc. Considering the second arc, all the adjacent arcs merge tangentially with one another first→second→third. Expediently, an arc with a radius of zero is treated like an arc of which the radius is equal to eps, where eps is a very small positive real number that tends towards 0 (eps<<1, eps→0).
4. An arc of the generating screw profile respectively “corresponds” to an arc of the generated screw profile, “corresponding” being understood as meaning that
   the angles of corresponding arcs are of the same size,
   the sum of the radii of corresponding arcs is equal to the centreline distance a,
   one of the joining lines between the centre point of an arc of the generating screw profile and the end points thereof in each case runs parallel to one of the joining lines between the centre point of the corresponding arc of the generated screw profile and the end points thereof,
   the directions in which the end points of an arc of the generating screw profile lie from the centre point of the arc are respectively opposite the directions in which the end points of the corresponding arc of the generated screw profile lie from the centre point of the arc of the generated screw profile,
   the centre point of an arc of the generating screw profile is at a distance from the centre point of a corresponding arc of the generated screw profile that corresponds to the centreline distance,
   the joining line between the centre point of an arc of the generating screw profile and the centre point of the corresponding arc of the generated screw profile is parallel to the joining line between the point of rotation of the generating screw profile and the point of rotation of the generated screw profile,
   the direction in which the centre point of an arc of the generating screw profile would have to be displaced to make it coincide with the centre point of the corresponding arc of the generated screw profile is the same as the direction in which the point of rotation of the generating screw profile has to be displaced to make it coincide with the point of rotation of the generated screw profile.

On the basis of these fundamental principles, a design method for the profiles of paired fully wiping screw shafts can be formulated.

The profiles in this case preferably lie in one plane. The axis of rotation of the generating screw profile and the axis of rotation of the generated screw profile are respectively perpendicular to said plane, the points of intersection of the axes of rotation with said plane being referred to as points of rotation. The distance of the points of rotation from one another is referred to as the centreline distance a. Hereafter, π should be understood as representing the constant of a circle (π≈3.14159).

In a first step, the generating screw profile is generated. The generating screw profile dictates the generated screw profile.
A number n of arcs that are intended to form the generating screw profile is chosen, n being a whole number greater than or equal to 1.
An outer radius ra is chosen, ra being able to assume a value that is greater than 0 (ra>0) and less than or equal to the centreline distance (r≦a).
An inner radius ri is chosen, ri being able to assume a value that is greater than or equal to 0 (ri≧0) and less than or equal to ra (ri≦ra).
n arcs are arranged clockwise or anticlockwise around the axis of rotation of the generating screw profile in a way corresponding to the following rules of arrangement:
   the sizes of n−1 arcs are fixed by the selectable angles α_{—}1, α_{—}2, . . . , α_(n−1) and the selectable radii r_{—}1, r_{—}2, . . . , r_(n−1), the angles in radian measure being greater than or equal to 0 and less than or equal to 2π and the radii being greater than or equal to 0 and less than or equal to the centreline distance a,
   the angle α_n of a last arc is obtained by the sum of the n angles of the n arcs in radian measure being equal to 2π,
   the radius r_n of a last arc is obtained by this last arc closing the profile,
   all the arcs merge tangentially with one another in such a way that a convex profile is obtained,
   an arc of which the radius is equal to 0 is preferably treated like an arc of which the radius is equal to eps, where eps is a very small positive real number that tends towards 0 (eps<<1, eps→0),
   each of the arcs lies within or on the limits of a circular ring with the outer radius ra and the inner radius ri, the centre point of which lies on the point of rotation of the generating screw profile,
   at least one of the arcs makes contact with the outer radius ra,
   at least one of the arcs makes contact with the inner radius ri.
The number n′ of arcs that form the generated screw profile, their angles α_{—}1′, α_{—}2′, . . . , α_′and their radii r_{—}1′, r_{—}2′, . . . , r_n′ are obtained as follows:
   n′=n
   α_{—}1′=α_{—}1; α_{—}2′=α_{—}2; . . . ; α_n′=α_n
   r_{—}1′=a−r_{—}1; r_{—}2′=a−r_{—}2; . . . r_n′=a−r_n
The positions of the n′ arcs that form the generated screw profile are obtained as follows:
   the centre point of the i′th arc of the generated screw profile has a distance from the centre point of the ith arc of the generating screw profile that is equal to the centreline distance a,
   the centre point of the i′th arc of the generated screw profile has a distance from the point of rotation of the generated screw profile that corresponds to the distance of the centre point of the ith arc of the generating screw profile from the point of rotation of the generating screw profile,
   the joining line between the centre point of the ith arc of the generated screw profile and the centre point of the ith arc of the generating screw profile is a parallel to a joining line between the point of rotation of the generated screw profile and the point of rotation of the generating screw profile,
   a starting point of the i′th arc of the generated screw profile lies in a direction with respect to the centre point of the ith arc of the profile of the generated screw profile that is opposite to that direction in which a starting point of the ith arc of the profile of the generating screw profile lies with respect to the centre point of the ith arc of the generating screw profile,
      where i and i′ are whole numbers that together run through all the values in the range from 1 to the number of arcs n and n′ (i′=i), respectively.

The design method can in principle be carried out on paper just with a set square and a pair of compasses. For example, the tangential transition between the ith arc and the (i+1)th arc of the profile of a screw element can be constructed by describing a circle with the radius r_(i+1) around the end point of the ith arc and the point of intersection, situated closer to the point of rotation of the screw element, of the circle with the straight line that is defined by the centre point and the end point of the ith arc being the centre point of the (i+1)th arc. More practically, instead of using a drawing pad, a set square and a pair of compasses, the profiles will be generated virtually with the aid of a computer.

In the application PCT/EP2009/003549, further design specifications for paired fully wiping screw profiles are described. This discusses variants that are obtained when the structural design is performed for example using a Cartesian system of coordinates or if the screw profiles have certain symmetries.

The fundamental principles and the design specifications based on them allow, for the first time, the profile of self-cleaning screw elements to be designed almost completely freely, and consequently optimized for an application by minor variation of parameters. In addition, it is possible to approximate with the desired accuracy screw profiles that are not made up of arcs, and are consequently not self-cleaning, by an adequately high number of arcs. In this case, the profile approximated by means of arcs is of course self-cleaning.

In this way geometries of screw extruders also have access to an optimization according to the invention using a data-based model. For this purpose, firstly three-dimensional screw elements have to be generated from the two-dimensional profiles. All conceivable screw elements and transitional elements can be generated from the designed screw profiles. In particular, conveying, kneading and mixing elements can be generated.

As is known (see for example [1], pages 227-248), a conveying element is distinguished by the fact that the screw profile is continuously turned in a helical manner and continued in the axial direction. In this case, the conveying element may be right-handed or left-handed. The pitch of the conveying element is preferably in the range of 0.1 to 10 times the centreline distance, the pitch being understood as meaning the axial length that is required for a complete rotation of the screw profile, and the axial length of a conveying element preferably lying in the range of 0.1 to 10 times the centreline distance.

As is known (see for example [1 ], pages 227-248), a kneading element is distinguished by the fact that the screw profile is continued in the axial direction in an offset manner in the form of kneading discs. The arrangement of the kneading discs may be right-handed or left-handed or neutral. The axial length of the kneading discs is preferably in the range of 0.05 to 10 times the centreline distance. The axial distance between two adjacent kneading discs is preferably in the range of 0.002 to 0.1 times the centreline distance.

As is known (see for example [1], pages 227-248), mixing elements are distinguished by the fact that conveying elements are provided with apertures in the screw flight lands. The mixing elements may be right-handed or left-handed. Their pitch preferably lies in the range of 0.1 to 10 times the centreline distance and the axial length of the elements preferably lies in the range of 0.1 to 10 times the centreline distance. The apertures preferably have the form of a u-shaped or v-shaped groove, which is preferably arranged counter-conveying or axially parallel.

Transitional elements is the term used to refer to screw elements that make a continuous transition between two different screw profiles possible, a self-cleaning pair of screw profiles being present at each point of the transition. The various screw profiles may have, for example, different numbers of flights. Transitional elements may be right-handed or left-handed. Their pitch preferably lies in the range of 0.1 to 10 times the centreline distance and their axial length preferably lies in the range of 0.1 to 10 times the centreline distance.

It is known to a person skilled in the art that directly wiping screw profiles cannot be used directly in a twin-screw extruder, but rather that clearances between the screws are required. A person skilled in the art knows methods for deriving a screw with clearances from a prescribed, fully wiping screw profile. Known methods for this are, for example, the possibility described in [1] on pages 28 et seq. of increasing the centreline distance, the longitudinal-sectional equidistants and the spatial equidistants. In the case of increasing the centreline distance, a screw profile of a smaller diameter is constructed and pulled apart by the amount of clearance between the screws. In the case of the method of longitudinal-sectional equidistants, the longitudinal-sectional profile curve (parallel to the axis of rotation of the respective element) is displaced inwards perpendicularly to the profile curve, in the direction of the axis of rotation, by half the screw-screw clearance. In the case of the method of spatial equidistants, starting from the space curve on which the screw elements clean one another, the screw element is reduced in size by half the screw-screw clearance in the direction perpendicular to the surfaces of the fully wiping profile. The longitudinal-sectional equidistant and the spatial equidistant are preferably used, particularly preferably the spatial equidistant.

1. A method for creating a forecasting tool for a screw extruder and/or an extrusion process, at least comprising:
(a) defining a parameter space,
(b) selecting representative combination of values within the parameter space,
(c) calculating at least one result characteristic for selected combination of values with aid of a simulation calculation,
(d) creating a data-based model on the basis of the selected combination of values and/or the calculated result characteristic,
(e) optionally repeating one or more of (a) to (e), until the result characteristic can be calculated sufficiently accurately with aid of the data-based model.

2. A method for forecasting behaviour of a screw extruder in extrusion of an extruded material, at least comprising:
(I) creating a data-based model as a forecasting tool,
(II) inputting one or more characterizing values for a screw extruder, extrusion process and extruded material into the data-based model,
(III) calculating at least one result characteristic by means of the data-based model,
(IV) outputting a result.

3. A method for optimizing geometry of a screw extruder and/or extrusion process, at least comprising:
(A) creating a data-based model as a forecasting tool,
(B) defining a target profile for the screw extruders and/or the extrusion process,
(C) identifying one or more combinations of values that satisfy the defined target profile and/or come closest to the target profile,
(D) outputting the one or more combinations of values determined in step (C).

4. A method for producing a screw extruder, at least comprising:
creating a data-based model as a forecasting tool,
(ii) defining a target profile for the screw extruder and/or an extrusion process,
(iii) identifying one or more combinations of values for the screw extruder that satisfy the defined target profile and/or come closest to the target profile,
(iv) outputting and/or storing the one or more combinations of values determined in (iii),
(v) creating screw extruders on the basis of the one or more combinations of values determined in (iii).

5. The method according to claim 4, wherein said profile of screw extruder is described by an arc of a circle,

6. The method according to claim 5, wherein said arc that describes a profile merge tangentially with one another at a starting point and/or end point, a kink in a profile being described by an arc of which the radius is equal to 0.

7. A forecasting tool for a screw extruder and/or extrusion process generated by said method according to claim 1.

8. A computer system for carrying out a method according to claim 1.

9. A computer program product comprising program coding means for carrying out a method according to claim 1 on a computer.

10. A forecasting tool for a screw extruder and/or extrusion process generated by said method according to claim 5.

11. A forecasting tool for a screw extruder and/or extrusion process generated by said method according to claim 6.

12. A computer system for carrying out a method according to claim 2.

13. A computer program product comprising program coding means for carrying out a method according to claim 2 on a computer.

14. A computer system for carrying out a method according to claim 3.

15. A computer program product comprising program coding means for carrying out a method according to claim 3 on a computer.

16. A computer system for carrying out a method according to claim 4.

17. A computer program product comprising program coding means for carrying out a method according to claim 4 on a computer.
